(19) United States
(12) Patent Application Publication
(10) Pub. No.: US 2013/0169233 A1
(43) Pub. Date: Jul. 4, 2013

(54) CHARGING METHOD AND CHARGING SYSTEM

(71) Applicants: Hiromi Tonegawa, Kounan-shi (JP); Tetsuhiro Ishikawa, Miyoshi-shi (JP); Shinji Ichikawa, Toyota-shi (JP); Daisuke Ishii, Toyota-shi (JP); Katsutoshi Murawaka, Kasugai-shi (JP)

(72) Inventors: Hiromi Tonegawa, Kounan-shi (JP); Tetsuhiro Ishikawa, Miyoshi-shi (JP); Shinji Ichikawa, Toyota-shi (JP); Daisuke Ishii, Toyota-shi (JP); Katsutoshi Murawaka, Kasugai-shi (JP)

(73) Assignees: TOYOTA JIDOSHA KABUSHIKI KAISHA, Toyota-shi, Aichi-ken (JP); TOYOTA HOUSING CORPORATION, Nagoya-shi, Aichi-ken (JP); DENSO CORPORATION, Kariya-shi, Aichi-ken (JP)

(21) Appl. No.: 13/813,066

(22) PCT Filed: Aug. 4, 2011
(86) PCT No.: PCT/IB11/01808

§ 371 Date: Mar. 15, 2013

(30) Foreign Application Priority Data
Aug. 5, 2010 (JP) 2010-176631

(51) Int. Cl. H02J 7/00

(52) U.S. Cl. CPC H02J 7/007
USPC 320/134; 320/162

(57) ABSTRACT

Use start date-and-time is input by use of U1. Times T1 and T2 to achieve SOC 1 and SOC 2 are set. Charging is started at T2 and is continued until it is determined that SOC 2 is achieved. Thereafter, charging is started at T1 and continued until it is determined that SOC 1 is achieved by the input use start date-and-time.

### BACKGROUND OF THE INVENTION

1. Field of the Invention

The present invention relates to a charging system and a charging method, particularly a charging method and a charging system for charging a storage battery that capacity degradation is accelerated more when a state of charge becomes higher.

2. Description of the Related Art

Some storage batteries such as lithium-ion batteries may undergo accelerated capacity degradation when they are stored in fully charged states. Lithium-ion batteries are installed in hybrid vehicles and electric vehicles, and the like. In these cases, acceleration of capacity degradation may impact distance-to-empty, etc.

Japanese Patent Application Publication No. 2009-118652 discloses a charging technology for such an in-vehicle battery. This technology includes a communication relay equipment for communicably connecting an electric vehicle with an electric power server provided in a consumer's house so that the battery can be charged at a lower electricity price in the consumer's house in which the battery of the electric vehicle is charged. The electric power server includes, a database that stores information such as the electricity price for each time zone in the electricity-billing plan in a contract for each consumer's house H, and a database that stores charging characteristics of each battery. In this technology, when the electric power server receives a charge completion time and consumer's house identification information from an electric vehicle 2 via a communication relay equipment 4, a charging start time is calculated such that charge is completed by a charge completion designated time and the electricity price for the charging is saved on the basis of the billing plan in the contract for the consumer's house.

However, the technology disclosed in Japanese Patent Application Publication No. 2009-118652 has a problem that since the battery is kept in a fully charged state between the time at which the charging is completed and the charge completion designated time, degradation of the storage battery is accelerated.

### SUMMARY OF THE INVENTION

The present invention provides a charging system that is fully charged when a storage battery is to be used and that is capable of hindering capacity degradation of the storage battery.

A first aspect of the present invention provides a charging method including: a step of inputting use start date-and-time of electric power charged in a storage battery by an inputting means; a first charging controlling step of controlling charging to the storage battery by a controlling means so that the storage battery is charged to a predetermined first state of charge; and a second charging controlling step of controlling charging to the storage battery by the controlling means so that charging to a predetermined second state of charge higher than the first state of charge is completed by the use start date-and-time that are input in the inputting step.

According to the above aspect, charging to the storage battery is controlled so that the charging to the first state of charge is conducted and thereafter the charging to the second state is completed by the use start date-and-time. Accordingly, the time period during which the battery is kept in the fully charged state can be reduced, and capacity degradation of the storage battery can be thereby hindered. Further, duration of an empty state of the storage battery causes an inactive state and accelerates degradation. However, the storage battery is temporarily charged to the first state of charge, thereby activating the storage battery by charging and hindering degradation. Since charging is completed punctually by the use start date-and-time, the storage battery can be warmed up, and as a result an active state of the storage battery can be obtained.

In a case that electricity price necessary for charging differs according to particular periods or time zones, the charging means may be controlled to conduct charging in a period or a time zone in which an electricity price necessary for charging to the first state of charge can be the lowest on the basis of price information about an electricity price in each period or time zone.

Control is made as described above, and the electricity price can be thereby reduced. Particularly, this method is preferable when the electricity price necessary for the charging to the first state of charge is higher than the electricity price necessary for the charging from the first state of charge to the second state of charge.

The charging method may further include an obtainment step of obtaining price information by an obtainment means. Accordingly, even if the information about the electricity price for each period or time zone is sequentially updated, quick response is possible.

The controlling means may operate further control so that a charging start time is determined on the basis of the use start date-and-time and the price information and the charging to the first state of charge is thereby started.

The storage battery may be charged to the first state of charge that hinders capacity degradation of the storage battery and that enables predetermined long period storage.

The storage battery may be charged to the second state of charge that accelerates capacity degradation of the storage battery more than in the first state of charge and that enables predetermined short period storage or only short period storage.

The charging method may further include a discharging step of discharging electric power charged in the storage battery to the first state of charge by a discharging means in a case that a predetermined period passes after the use start date-and-time although the storage battery is not used.

In other words, for example, in a case that a user does not use the storage battery due to his/her circumstances although the storage battery has been charged, capacity degradation is accelerated. However, the electric power is discharged, thereby hindering capacity degradation in such a case.

The charging method may further include a detection step of detecting by a detection means whether a state of charge of the storage battery has become the first state of charge and detecting whether the state of charge has become the second state of charge. The controlling step may obtain a detection result by the detection means and thereby control the charging means in response to the detection result.

As described above, the detection means is provided, so that the capacity of the storage battery can be accurately known.

A second aspect of the present invention provides a charging system including: a charging means for charging a storage battery; an inputting means for inputting use start date-and-time of electric power charged in the storage battery; and a control means for controlling the charging means to charge the storage battery to a predetermined first state of charge and for controlling the charging means to complete charging to a predetermined second state of charge higher than the first state of charge by the use start date-and-time that are input by the inputting means.

According to the aspect, the storage battery is charged by the charging means, and the use start date-and-time of the electric power charged in the storage battery are input by the inputting means.

Further, the control means controls the charging means to charge the storage battery to the predetermined first state of charge and to complete the charging to the predetermined second state of charge higher than the first state of charge by the use start date-and-time that are input by the inputting means. In other words, the control means operates control so that the charging to the first state of charge is conducted and the charging to the second state is subsequently completed by the use start date-and-time. Accordingly, the time period during which the battery is kept in the fully charged state can be reduced. As a result, capacity degradation of the storage battery can be hindered. Further, duration of an empty state of the storage battery causes an inactive state and accelerates degradation. However, the storage battery is temporarily charged to the first state of charge, thereby activating the storage battery by charging and hindering degradation. Since charging is completed punctually by the use start date-and-time, the storage battery can be warmed up, and as a result an active state of the storage battery can be obtained.

In a case that an electricity price necessary for charging differs according to particular periods or time zones, the control means may control the charging means to charge the storage battery in a period or a time zone in which an electricity price necessary for charging to the first state of charge is the lowest on the basis of price information about an electricity price in each period or time zone.

Control is made as described above, and the electricity price can be thereby reduced. Particularly, this system is preferable when the electricity price necessary for the charging to the first state of charge is higher than the electricity price necessary for the charging from the first state of charge to the second state of charge.

In such a case, the charging system may further include an obtainment means for obtaining price information. Accordingly, even if the information about the electricity price for each period or time zone is sequentially updated, quick response is possible.

The control means may operates further control so that a charging start time for charging to the first state of charge is determined on the basis of the use start date-and-time and the price information and the charging to the first state of charge is thereby started.

The control means may conduct charging to the first state of charge that is a predetermined state of charge that hinders capacity degradation of the storage battery and that enables long period storage. The control means may conduct charging to the second state of charge that accelerates capacity degradation of the storage battery more than at the first state of charge and that enables predetermined short period storage or only short period storage.

The charging system may further include a discharging means for discharging electric power charged in the storage battery to the first state of charge in a case that a predetermined period passes after the use start date-and-time although the storage battery is not used.

In other words, for example, in a case that a user does not use the storage battery due to his/her circumstances although the storage battery has been charged, capacity degradation is accelerated. However, the electric power is discharged, thereby hindering capacity degradation in such a case.

Further, the charging system may further include a detection means for detecting whether a state of charge of the storage battery has become the first state of charge and for detecting whether the state of charge has become the second state of charge. The control means may obtain a detection result and thereby control the charging means in response to the detection result.

As described above, the detection means is provided, and the capacity of the storage battery can be thereby accurately known.

The present invention provides an advantage that a charging system is provided in a fully charged state when a storage battery is used and that capacity degradation of the storage battery is hindered.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 shows an exemplary configuration of a charging system;

FIG. 2 shows an exemplary configuration of a charging device;

FIG. 3 shows an example of a UI;

FIG. 4 is a graph representing an outline of a charging method;

FIG. 5 is a flowchart illustrating a process flow of the charging method (first process flow);

FIG. 6 is a flowchart illustrating a process flow of the charging method (second process flow); and

FIG. 7 is a flowchart illustrating a process flow of a discharging method.

### DETAILED DESCRIPTION OF THE PREFERRED EMBODIMENTS

An embodiment of the present invention will be described hereinafter in detail with reference to drawings.

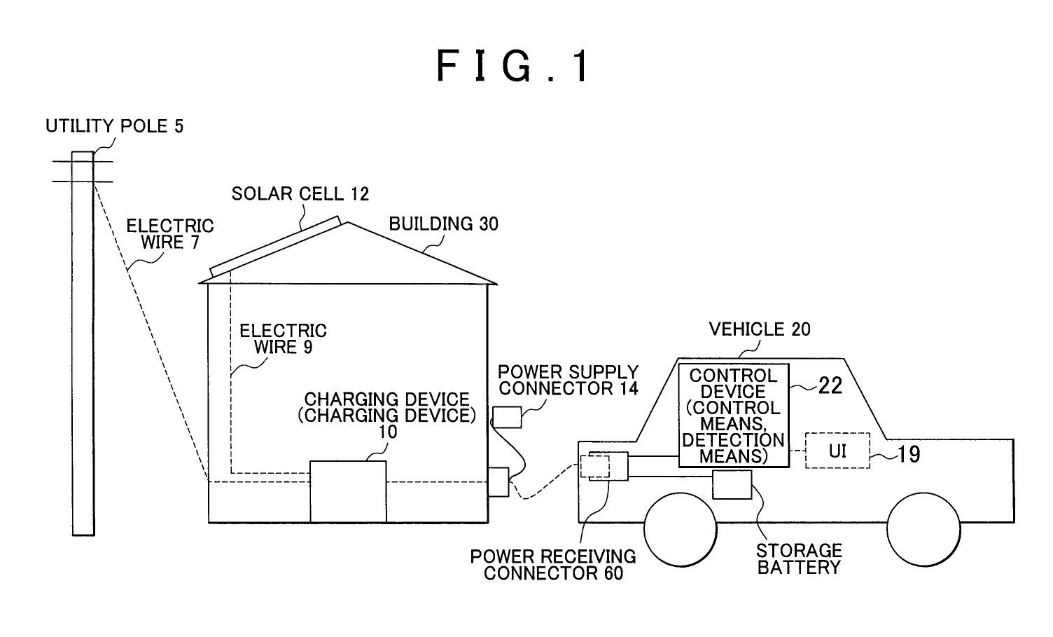

FIG. 1 shows a configuration including a charging system in accordance with the present invention. The drawing shows a utility pole 5, electric wires 7 and 9, a building 30, a solar cell 12, a charging device 10, a power supply connector 14, and a vehicle 20.

Among those, the utility pole 5 supplies electric power from a power system. The electric power is supplied to the building 30 through the electric wire 7 and particularly supplied to the charging device 10 in this embodiment. The solar cell 12 converts light energy into electric power, and the electric power is supplied to the charging device 10 through the electric wire 9. The power supply connector 14 supplies electric power to the vehicle 20. The charging device 10 controls charging to a storage battery 24 provided in the vehicle 20. Details about the charging device 10 will be described later.

The vehicle 20 further has a power receiving connector 60, the storage battery 24, a control device 22, and a UI (user interface) 19. The power receiving connector 60 is connected to the power supply connector 14 and supplies electric power that is supplied from the power supply connector 14 to the vehicle. Electric power supplied from the power receiving connector 60 is supplied to the control device 22, the storage battery 24, and the UI 19.

The control device 22 is configured with a CPU (central processing unit), a RAM (random access memory), and a ROM (read only memory), and so forth, which are all not shown. The control device 22 detects a state of charge of the storage battery 24 and controls the UI 19. The storage battery 24 is, for example, a lithium-ion battery and has the property that capacity degradation is accelerated more when the state of charge becomes higher. The UI 19 is used for inputting a use start date-and-time of the storage battery 24 and has functions similar to a UI of the charging device 10, which will be described later. Among those configuring portions, the charging device 10, the control device 22, the UI 19, the storage battery 24, parts that supply electric power to the charging device 10, and parts that are electrically connected to enable charging from the charging device 10 to the storage battery 24 are included in the configuration of the charging system.

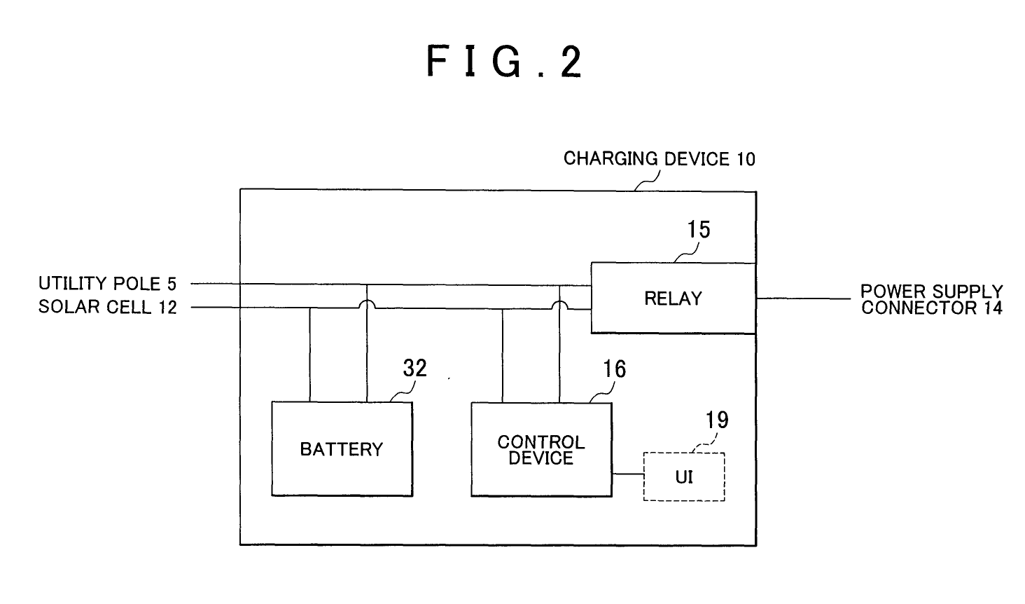

Next, a configuration of the charging device 10 will be described with reference to FIG. 2. The charging device 10 includes a battery 32, a control device 16, the UI 19, and a relay 15. As described above, the charging device 10 is supplied with electric power from the utility pole 5 and the solar cell 12. The supplied electric power is supplied to the power supply connector 14, the control device 16, and the UI 19 via the battery 32 and the relay 15.

Among those, the battery 32 is used for temporarily storing the supplied power and is charged by use of midnight power service whose price is generally low. The control device 16 is configured with a CPU, a RAM, a ROM, and so forth, which are all not shown. The control device 16 controls the charging device 10 such that the storage battery 24 is charged to a predetermined first state of charge (SOC 2 which will be described later) and charging to a second state of charge (SOC 1 which will be described later) higher than the first state of charge is completed by the use start date-and-time. Further, for example, in a case that a time period between the point at which the use start date-and-time are input and the use start date-and-time is longer than the time period during which the storage battery is charged to the second state of charge, the control device 16 controls the charging device 10 for charging the storage battery to complete the charging to the second state of charge by the use start date-and-time. The second state of charge will be described later.

The UI 19 is used for inputting the use start date-and-time of the storage battery 24, similarly to the above-described UI provided in the vehicle 20. In this embodiment, the UI may be provided in either one of the charging device 10 or the vehicle 20. In FIG. 2, although the UI 19 is provided inside the charging device 10, the UI may be provided outside if the UI is capable of communicating with the control device 16.

The relay 15 is a switch for enabling and disabling power supply to the power supply connector 14 and is controlled by the control device 16.

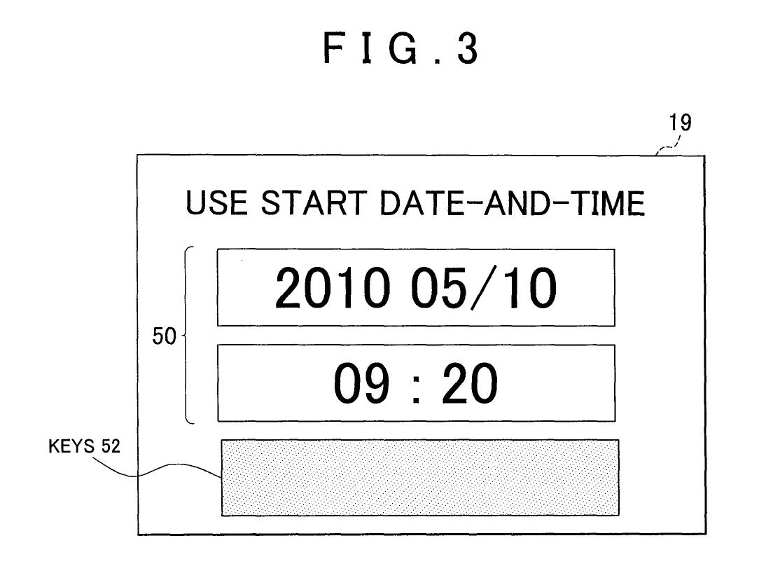

Next, an example of the UI 19 will be described with reference to FIG. 3. As shown in the drawing, the UI 19 includes use start date-and-time display frames 50 and keys 52. The drawing shows that 9:20 a.m., May 10, 2010 is the use start date-and-time. The keys 52 are used by a user to set the use start date-and-time and acceptable as long as the use start date-and-time can be set the key 52 are for example a numeric keypad or arrow keys for up, down, left, and right.

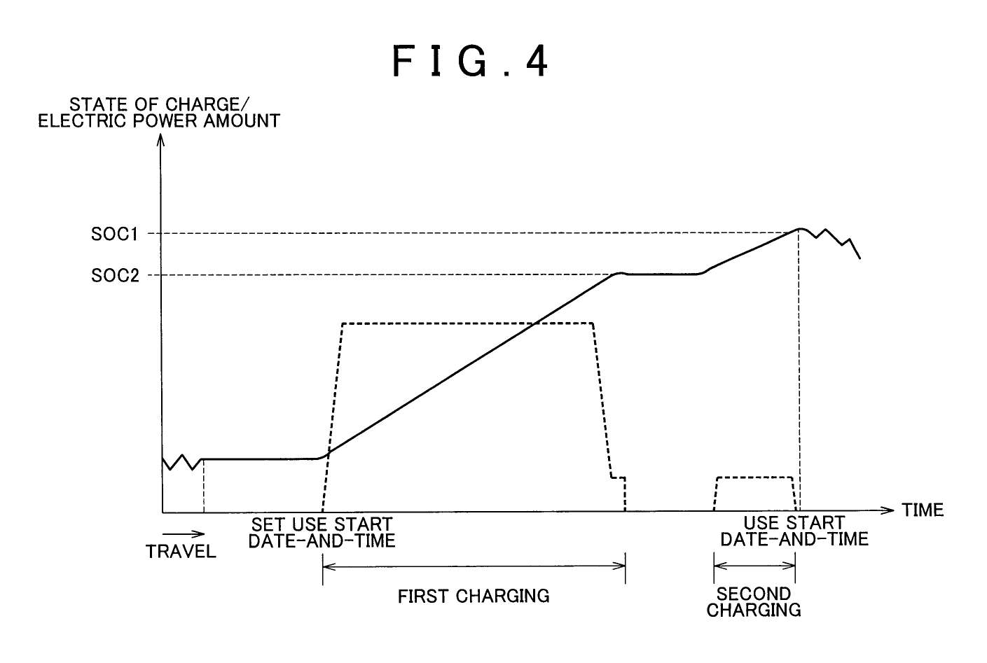

Next, an outline of a charging method in accordance with this embodiment that is carried out with the above-described configuration will be described with reference to FIG. 4.

Vertical axis of the graph in FIG. 4 represents the state of charge of the storage battery 24 and an electric power amount for charging, and the horizontal axis represents the time. The solid line represents the state of charge, and the broken line represents the electric power amount. SOC 1 denotes the above-described second state of charge, which is the state of charge in the fully charged state. According to vehicle types, there are cases that chargeable amount is intentionally limited to approximately 80% of the fully charged state. In those cases, SOC 1 is 80% of the fully charged state. In the fully charged state, electric power storage accelerates capacity degradation, and electric power can be stored for a predetermined short period, but only the short period storage is possible.

On the other hand, SOC 2 denotes the above-described first state of charge, which hinders capacity degradation compared to the storage at SOC 1 and enables longer storage than SOC 1. An example of SOC 2 is an approximately 80% state of charge with respect to the fully charged state. In a case that SOC 1 is the 80% state of charge, SOC 2 may be a further lower state of charge.

The graph illustrates a case that the vehicle 20 first travels and returns to the building 30 and the user thereafter sets the use start date-and-time. The drawing shows a case that the time period between the point at which the use start date-and-time are input and the use start date-and-time is longer than time period necessary for charging the storage battery 24 to SOC 1.

In this embodiment, the control devices 16 and 22 control the charging device 10 in advance to charge the storage battery 24 to SOC 2 lower than SOC 1 (first charging), and subsequently control the charging device 10 to complete charging to SOC 1 by the use start date-and-time (second charging). As described above, the charging is completed punctually by the use start date-and-time. Accordingly, duration of the state in which the charging to the storage battery 24 has been completed can be reduced to a minimum, thereby hindering capacity degradation of the storage battery 24. Further, duration of an empty state of the storage battery causes an inactive state and accelerates degradation. However, the storage battery is temporarily charged to SOC 2, thereby activating the storage battery by charging and thus hindering degradation. Since charging is completed punctually by the use start date-and-time, the storage battery can be warmed up, and as a result an active state of the storage battery can be obtained.

In the following descriptions, the control devices 16 and 22 are denoted as the control device 16 for convenience. However, in the case that the control device 22 carries out a process different from that of the control device 16, the control device will be referred to as the control device 22.

In this embodiment, in a case that the time period between the point at which the use start date-and-time are input by the UI 19 and the use start date-and-time is longer than the time period during which the storage battery 24 is charged to SOC 1, the control device 16 controls the charging device 10 for charging the storage battery 24 to complete the charging to SOC 1 by the use start date-and-time.

In the same drawing, charging is started immediately after the use start date-and-time is input. However, in a case that an electricity price necessary for charging differs according to periods or time zones, the ROM stores an electricity price in each period or each time zone, and the charging device 10 is thereby controlled to conduct charging in a period or a time zone during which the electricity price necessary for previously charging to SOC 2 can be the lowest. Further, in a case that a communication interface for obtaining information about the electricity price for each period or each time zone from an electric power company, or the like is provided, the information about electricity prices may be obtained by the communication interface.

For example, if the first charging needs 3 hours, the second charging needs 1 hour, the point at which the use start date-and-time (for example, 9:00 a.m., May 10th) are input is 3:00 p.m., May 9th, and if the electricity price is the lowest from 0 a.m. to 4 a.m., the first charging is conducted between 0 a.m. and 4 a.m.

Detections by the control device 16 about whether the state of charge of the storage battery 24 has become SOC 1 and whether the state of charge has become SOC 2 can be carried out by the following two exemplary detection methods.

In a first detection method, the control device 16 communicates with the control device 22 of the vehicle 20 for detecting the state of charge of the storage battery 24, thereby detecting the state of charge of the storage battery 24. In this case, the control device 16 needs a communication interface for communicating with the control device 22.

In a second detection method, in the case that an electric power amount charged to the storage battery 24 is controlled by the control device 22 of the vehicle 20, the state of charge can be detected by monitoring the electric power amount. Specifically, in a case that a first electric power supply is conducted via the control device 16, the control device 22 reduces the electric power amount as shown in FIG. 4 when SOC 2 is achieved. This reduction can be easily detected if the control device 16 monitors the electric power amount. Accordingly, the control device 16 can detect that the state of charge of the storage battery 24 has become SOC 2. Similarly, the electric power amount is reduced as shown in FIG. 4 when the second charging is finished, and the control device 16 thus can detect that the state of charge has become SOC 1.

In response to the detection results obtained in such a manner, the control device 16 may control the charging device 10.

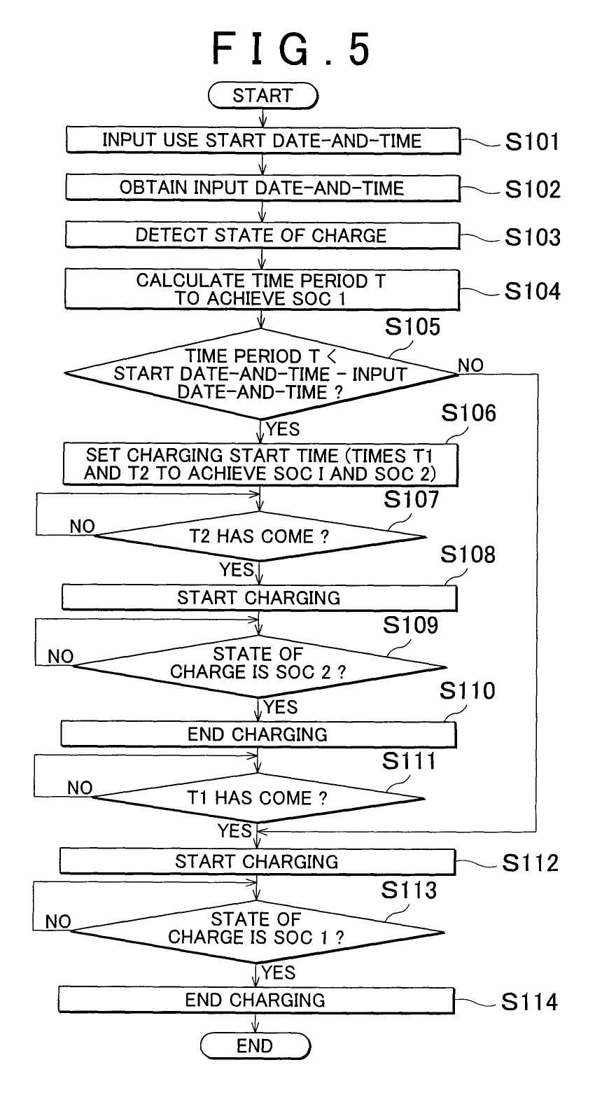

The process of the above-described charging method will be described in detail with reference to flowcharts. First, a process flow of the charging method (first process flow) will be described with reference to FIG. 5. The flowchart of FIG. 5 illustrates the process flow executed by the control device 22.

First, in step 101, a user uses the UI 19 to input the use start date-and-time (hereinafter simply referred to as “start date-and-time”). At this point, the input date-and-time is obtained in step 102. In step 103, the state of charge of the storage battery 24 is detected.

Next, in step 104, a time period for achieving SOC 1 is calculated from the detected present state of charge. In next step 105, a determination is made whether the time period T is shorter than the time period that is the result of subtraction of the input date-and-time from the start date-and-time. In other words, a determination is made whether the time period between the point at which the use start date-and-time are input and the use start date-and-time is longer than the time period necessary for charging the storage battery 24 to SOC 1.

In this step 105, if the determination is YES, that is, the time period between the point at which the use start date-and-time are input and the use start date-and-time is longer than the time period necessary for charging the storage battery 24 to SOC 1, the process goes to step 106. If the determination is NO, the process goes to step 112, and charging is immediately started.

In step 106, a charging start time is set. Specifically, a time T1 at which SOC 1 is achieved and a time T2 at which SOC 2 is achieved are set. Describing more specifically with the above-described example, if the first charging needs 3 hours, the second charging needs 1 hour, the time at which the use start date-and-time (for example, 9:00 a.m., May 10th) are input is 3:00 p.m., May 9th, and if the electricity price is the lowest from 0 a.m. to 4 a.m., T2 is set to 0:00 a.m. (or 1:00 a.m.) and T1 is set to 8:00 a.m.

In step 107, a determination is made whether T2 has come. If T2 has come, charging is started in step 108, the charging goes on until it is determined that the state of charge has become SOC 2 in step 109. When it is determined that the state of charge has reached SOC 2, the charging is finished in step 110.

In step 111, a determination is made whether T1 has come. If T1 has come, charging is started in step 112, and the charging goes on until it is determined that the state of charge has become SOC 1 in step 113. When it is determined that the state of charge has reached SOC 1, the charging is finished in step 114.

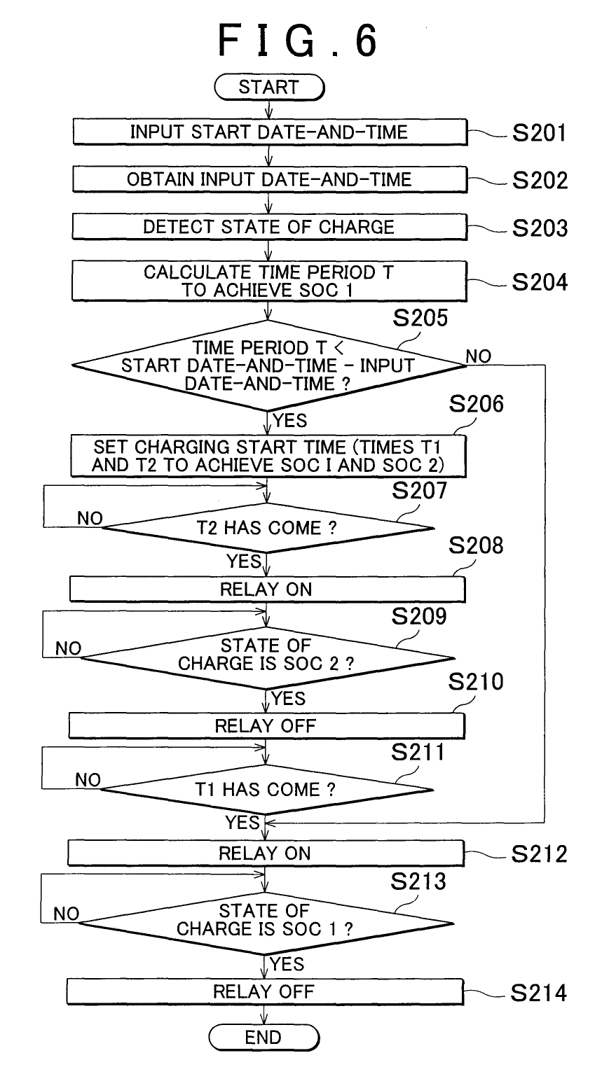

Next, a process flow of the charging method (second process flow) in which the control device 16 operates control will be described with reference to the flowchart of FIG. 6. Steps in the flowchart of FIG. 6 that are different from the process in the flowchart of FIG. 5 are steps 203, 208, 210, 212, and 214. Descriptions will be made only about these steps.

In step 203 for detecting the state of charge, the control device 16 obtains the state of charge that is detected by the control device 22. In steps 208 and 212 for turning the relay on and steps 210 and 214, the relay 15 is controlled, and electric power supply to the storage battery is thereby enabled or disabled. Detections of SOC 1 and SOC 2 are carried out by the above-described second detection method.

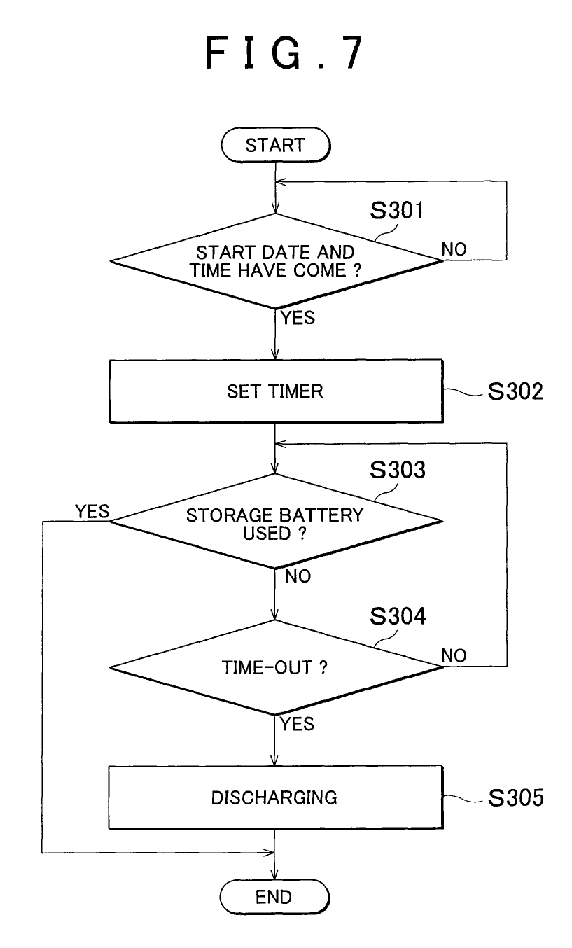

Next, with reference to the flowchart of FIG. 7, descriptions will be made about a process flow of discharging electric power stored in the storage battery in the case that the storage battery is not used although a predetermined period passes after the use start date-and-time. This process can be executed by either one of the control devices 16 or 22.

If it is determined that the start date-and-time have come in step 301, a timer is set in step 302. This timer is used for counting the predetermined period. In step 303, a determination is made whether the storage battery has been used. For the control device 16, the determination of the storage battery use may be made when the control device 22 notifies that a vehicle switch has been turned on by the user or when the power supply connector 14 is removed from the power receiving connector 60. On the other hand, for the control device 22, since it is installed in the vehicle 20, the determination can be made based on the vehicle state.

If the determination is YES in this step 303, the process ends. On the other hand, if the determination is NO, a determination is made whether a time-out has occurred with respect to the timer in step 302. If the determination is NO in step 304, the process returns to step 303. On the other hand, if the determination is YES, the electric power is discharged in step 305, and the process ends. Discharging the electric power to SOC 2 hinders capacity degradation and also shortens the period for charging to SOC 1.

There may be various discharging methods such as operating an air conditioner of the vehicle 20 and returning electric power to the building 30 to charge the battery 32.

The process flow illustrated by each of the flowcharts (FIGS. 5, 6, and 7) in the above-described embodiment is an example and may be appropriately modified without departing from the scope of the gist of the present invention. In this embodiment, although the descriptions are made with “use start date-and-time”, “use start date” may be used instead. In such a case, if a time of a predetermined use start date at which the fully charged state is achieved is previously set, the above-described embodiment is can be used without a change.

1. A charging method comprising:
inputting use start date-and-time of electric power charged in a storage battery;
determining whether a time period between an input date-and-time at which the use start date-and-time is input and the use start date-and-time is longer than a time period necessary for charging the storage batter to a predetermined second state of charge; and
controlling charging to the storage battery so that the storage battery is charged to a predetermined first state of charge lower than the second state of charge and controlling charging to the storage battery so that charging to the second state of charge is completed by the use start date-and-time if the time period between the input date-and-time and the use start date-and-time is longer than the time period necessary for charging the storage battery to the second state of charge,
wherein the controlling of the charging to the storage battery comprises:
setting a first time to achieve the first state of charge and a second time to achieve the second state of charge;
determining whether the first time has come, starting charging when the first time has come and finishing the charging when it is determined that the state of charge has reached the first state of charge; and
determining whether the second time has come, starting charging when the second time has come, and finishing the charging when it is determined that the state of charge has reached the second state of charge,
and wherein charging to the storage battery is immediately started if the time period between the input date-and-time and the use start date-and-time is equal to or shorter than the time period necessary for charging the storage battery to the second state of charge.

2. The charging method according to claim 1, wherein in a case that an electricity price necessary for charging differs according to particular periods or time zones, when the charge to the first state of charge is conducted, the charging is controlled to be conducted in a period or a time zone in which an electricity price necessary for charging to the first state of charge is the lowest on the basis of price information about an electricity price in each period or time zone.

3. The charging method according to claim 2, further comprising obtaining the price information.

4. The charging method according to claim 2, wherein the first time is determined on the basis of the use start data-and-time and the price information.

5. The charging method according to claim 1, wherein the storage battery is charged to the first state of charge that hinders capacity degradation of the storage battery and that enables predetermined long period storage.

6. The charging method according to claim 1, wherein the storage battery is charged to the second state of charge that accelerates capacity degradation of the storage battery more than the first state of charge and that enables predetermined short period storage or only short period storage.

7. The charging method according to claim 5, further comprising discharging electric power charged in the storage battery to the first state of charge in a case that a predetermined period passes after the use start date-and-time although the storage battery is not used.

8. The charging method according to claim 1, further comprising detecting whether a state of charge of the storage battery has become the first state of charge and detecting whether the state of charge has become the second state of charge, wherein charging to the storage battery is controlled in response to the detection result.

9. The charging method according to claim 1, wherein the starting of the charging comprises turning the relay on, and the finishing of the charging comprises turning the relay off.

10.-18. (canceled)

19. A charging system comprising:
a charging unit that charges a storage battery;
an inputting unit that inputs use start date-and-time of electric power charged in the storage battery; and
a control unit that determines whether a time period between an input date-and-time at which the use start date-and-time is input by the inputting unit and the use start date-and-time is longer than a time period necessary for charging the storage battery to a predetermined second state of charge and that controls the charging unit to charge the storage battery to a predetermined first state of charge lower than the second state of charge and to complete charging to the second state of charge by the use start date-and-time that are input by the inputting unit if the time period between the input date-and-time and the use start date-and-time is longer than the time period necessary for charging the storage battery to the second state of charge, wherein
the control unit sets a first time to achieve the second state of charge and a second time achieve the first state of charge;
the control unit determines whether the first time has come, and controls the charging unit to start charging when the first time has come and to finish the charging when it is determined that the state of charge has reached the first state of charge; and
the control unit determines whether the second time has come, and controls the charging unit to start charging when the second time has come and to finish the charging when it is determined that the state of charge has reached the second state of charge,
and wherein the control unit starts charging to the storage battery immediately if the time period between the input date-and-time and the use start date-and-time is equal to or shorter than the time period necessary for charging the storage battery to the second state of charge.

20. The charging system according to claim 19, wherein the control unit turns on a relay to start the charging and turns off the relay to finish the charging.

21. The charging system according to claim 19, wherein in a case that an electricity price necessary for charging differs according to particular periods or time zones, the control unit controls the charging unit to charge the storage battery in a period or a time zone in which an electricity price necessary for charging to the first state of charge is the lowest on the basis of price information about an electricity price in each period or time zone.

22. The charging system according to claim 19, further comprising an obtainment unit that obtains the price information.

23. The charging system according to claim 21, wherein the control unit determines the first time on the basis of the use start date-and-time and the price information.

24. The charging system according to claim 19, wherein the control unit conducts charging to the first state of charge that is a predetermined state of charge that hinders capacity degradation of the storage battery and enables long period storage.

25. The charging system according to claim 19, wherein the control unit conducts charging to the second state of charge that accelerates capacity degradation of the storage battery more than the first state of charge and that enables predetermined short period storage or only short period storage.

26. The charging system according to claim 24, further comprising a discharging unit that discharges electric power charged in the storage battery to the first state of charge in a case that a predetermined period passes after the use start date-and-time although the storage battery is not used.

27. The charging system according to claim 25, further comprising a discharging unit that discharges electric power charged in the storage battery to the first state of charge in a case that a predetermined period passes after the use start date-and-time although the storage battery is not used.

28. The charging system according to claim 19, further comprising a detection unit that detects whether a state of charge of the storage battery has become the first state of charge and that detects whether the state of charge has become the second state of charge, wherein the control unit obtains a detection result and thereby controls the charging unit in response to the detection result.

29. The charging method according to claim 6, further comprising discharging electric power charged in the storage battery to the first state of charge in a case that a predetermined period passes after the use start date-and-time although the storage battery is not used.
